(19) United States
(12) Patent Application Publication
(10) Pub. No.: US 2011/0126090 A1
(43) Pub. Date: May 26, 2011

(54) COMPONENT COOPERATION DEVICE, A COMPONENT COOPERATION METHOD, A METHOD OF UPDATING COMPONENTS OF A WEB PAGE AND A PROGRAM THEREOF

(75) Inventor: Kiyoto SATO, Tokyo (JP)

(73) Assignee: NEC CORPORATION, Tokyo (JP)

(21) Appl. No.: 12/950,813

(22) Filed: Nov. 19, 2010

(30) Foreign Application Priority Data
Nov. 24, 2009 (JP) 2009-266042

(51) Int. Cl. G06F 17/00

(52) U.S. Cl. 715/234

(57) ABSTRACT

A component cooperation device communicates with a terminal through a network and provides a web page to the terminal in response to a request to display the web page. The device updates components of the web page by identifying a standard parameter in content of a first component for the web page, in which the standard parameter has a name and a value. A second component of the web page is identified that has content that includes the standard parameter name that is also in the content of the first component. The content of the second component is updated by changing the standard parameter in the content of the second component to have the standard parameter value of the standard parameter in the content of the first component. The device creates creating the web page from the content of the first component and the update content of the second component.

This application is based upon and claims the benefit of priority from Japanese patent application No. 2009-266042, filed on Nov. 24, 2009, the disclosure of which is incorporated therein in its entirety by reference.

### BACKGROUND

The present invention relates to a component cooperation device, component cooperation method, a method of updating components of a web page and a program thereof More particularly, it relates to a method that allows a component to cooperate with another component.

For Example, Japanese Patent Laid-open Publication No. 2008-293152 discloses a technique which allows a cooperation originator web system and a cooperating web system to cooperate together by using cooperation meta information. The cooperation meta information is embedded in content and indicates the data type and data value of data to be passed to the cooperating web system.

In Japanese Patent Laid-open Publication No. 2008-293152, a developer of a component, for example, a portlet, needs to statically describe a cooperating portlet, data to be passed to the cooperating portlet, or the like in the source program of the portlet. Accordingly, when the interface of the cooperating portlet or data handled by the cooperating portlet are changed, the developer needs to modify the source program of the portlet.

An objective of certain embodiments of the present invention is to provide a component cooperation device, a component cooperation method, a method of updating components of a web page and a program thereof which are capable of easily implementing data linking between components without needing special care from developers of the components.

### SUMMARY OF THE INVENTION

An exemplary object of the embodiments of the present invention is to provide a component cooperation device, a component cooperation method, a method of updating components of a web page and a program thereof which are capable of easily implementing data linking between components without needing special care from developers of the components.

According to one aspect of the embodiments of the present invention, a component cooperation device configured to communicate with a terminal through a network and provide a web page to the terminal in response to a request to display the web page, the device comprising: an information management unit configured to manage component identification information and component arrangement information of one or more components to be displayed on the web page; a storage unit configured to store contents of the one or more components; a parameter information memory unit configured to store input parameter information for each of the components; a processing unit configured to create the web page specified by the request and send the web page to the terminal, in response to receipt of the request to display the web page, wherein the processing unit receives a first list and the component arrangement information from the information management unit upon receipt of the request from the terminal, the first list including the component identification information of the one or more components to be displayed on the web page, wherein the processing unit receives the contents of the one or more components stored in the storage unit based on the component identification information of the first list, wherein the processing unit receives a second list from the parameter information memory unit if the received contents includes a standard parameter information, the second list indicating the component identification information of the one or more components that includes the standard parameter information, wherein the processing unit updates the contents of the components indicated by the component identification information in the second list according to the standard parameter information included in the received contents, and wherein the processing unit creates the web page with the received contents and the updated contents according to the component arrangement information.

According to one aspect of the embodiments of the present invention, a component cooperation method for a component cooperation device configured to communicate with a terminal through a network and provide a web page to the terminal in response to a request from the terminal to display the web page, the method comprising: performing a predetermined process concerning components for the web page in response to receipt of the request to display the web page; creating the web page specified by the request; and sending the web page to the terminal, wherein the predetermined process comprises: receiving a first list and component arrangement information upon the receipt of the request, the first list including component identification information of the components to be displayed on the web page, receiving contents of the components corresponding to the component identification information included in the first list, stored in a storage unit, receiving a second list from a parameter information memory unit if a description of the received contents includes standard parameter information, the second list indicating component identification information of the components including the standard parameter information, updating contents of the components indicated in the second list according to the standard parameter information, and wherein the web page is created with the received contents and the updated contents according to the component arrangement information.

According to one aspect of the embodiments of the present invention, a method of updating components of a web page, comprising: identifying a standard parameter in content of a first component for the web page, the standard parameter having a name and a value; identifying a second component of the web page having content that includes the standard parameter name that is also in the content of the first component; updating the content of the second component by changing the standard parameter in the content of the second component to have the standard parameter value of the standard parameter in the content of the first component; and creating the web page from the content of the first component and the updated content of the second component.

According to one aspect of the embodiments of the present invention, A computer readable medium recording thereon a program for enabling computer to execute a method of a component cooperation method for a component cooperation device configured to communicate with a terminal through a network and provide a web page to the terminal in response to a request from the terminal to display the web page, the method comprising: performing a predetermined process concerning components for the web page in response to receipt of the request to display the web page; creating the web page specified by the request; and sending the web page to the terminal, wherein the predetermined process comprises: receiving a first list and component arrangement information upon the receipt of the request, the first list including component identification information of the components to be displayed on the web page, receiving contents of the components corresponding to the component identification information included in the first list, stored in a storage unit, receiving a second list from a parameter information memory unit if a description of the received contents includes standard parameter information, the second list indicating component identification information of the components including the standard parameter information, updating contents of the components indicated in the second list according to the standard parameter information, and wherein the web page is created with the received contents and the updated contents according to the component arrangement information.

According to one aspect of the embodiments of the present invention, a computer readable medium recording thereon a program for enabling computer to execute a method of updating components of a web page, comprising: identifying a standard parameter in content of a first component for the web page, the standard parameter having a name and a value; identifying a second component of the web page having content that includes the standard parameter name that is also in the content of the first component; updating the content of the second component by changing the standard parameter in the content of the second component to have the standard parameter value of the standard parameter in the content of the first component; and creating the web page from the content of the first component and the updated content of the second component.

### BRIEF DESCRIPTION OF THE DRAWING

Other features and advantages of various embodiments of the present invention will become apparent by the following detailed description and the accompanying drawings, wherein:

FIG. 1 is a schematic diagram to explain a portlet linking system of an exemplary embodiment of the present invention.

FIG. 2 is a diagram showing an example of a portal screen on a display and a description of an example of a portlet.

FIG. 3 is a diagram showing an example of portlet arrangement information stored in a portlet arrangement information memory unit.

FIG. 4 is a diagram showing an example of an HTML document with data marked up.

FIG. 5 is a diagram to explain standard parameters set in the portlet cooperation system.

FIG. 6 is a diagram showing an example of information stored in a portlet parameter information memory unit.

FIG. 7 is a diagram showing an example of definition information of a portlet parameter.

FIG. 8 is a diagram to explain in detail a process to update a portlet.

FIG. 9 is a flowchart to explain an operation of a portal server A.

### DETAILED DESCRIPTION

A first exemplary embodiment of the present invention will he described in detail below with reference to the drawings.

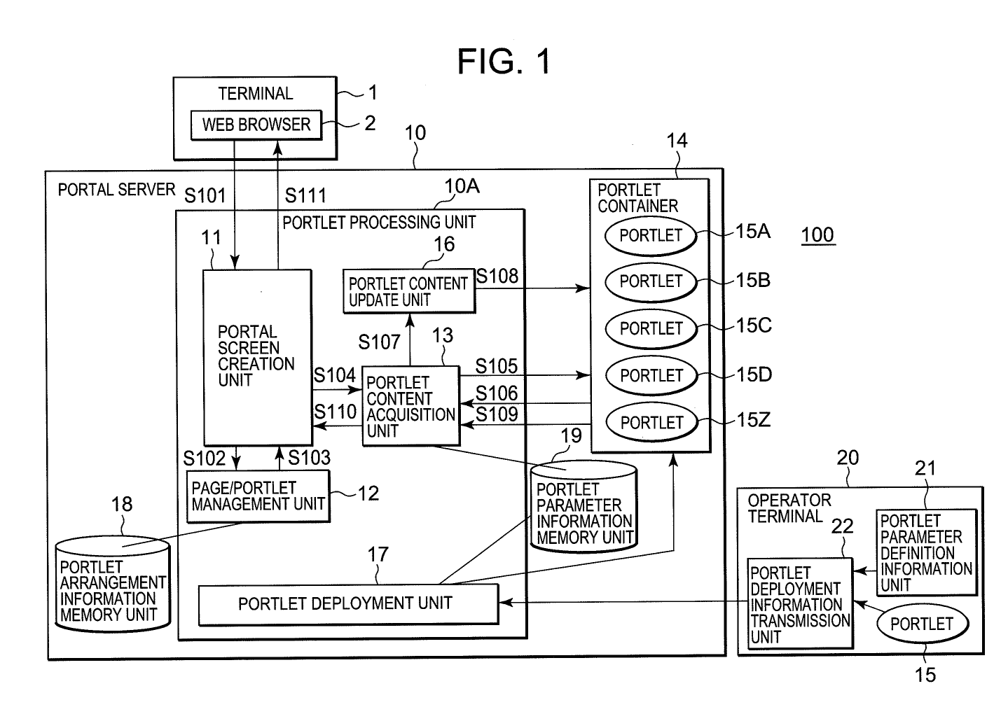

FIG. 1 is a diagram showing a configuration of a portlet cooperation system 100 implementing cooperation between portlets, to which an embodiment of the present invention is applied. The portlet cooperation system 100 includes a terminal 1, a portal server 10, and an operator terminal 20. The terminal 1 is connected to the portal server 10 so as to communicate with the portal server 10 through a network which is not shown in FIG. 1. The portal server 10 is also connected to the operator terminal 20 so as to communicate with the operator terminal 20 through a network, which also is not shown in FIG. 1. FIG. 1 shows only the single terminal 1, but the portal server 10 may be connected to a plurality of terminals 1 so as to communicate with the plurality of terminals 1 through a not-shown network.

Portlets are GUI (graphical user interface) components which can be arranged on a portal screen displayed on the terminal 1 and stored in a portlet container (described later) in the portal server 10. For example, the portlets are applications for use in business systems or groupware assisting collaborative creation by a group, but are not limited to these examples.

Each portlet includes two methods including a content display process and a content update process. The content display process is a process to return contents of the portlet specified by the portlet container, to the portlet container. The content update process is a process to update descriptions of the contents of the portlet specified by the portlet container.

Next, the functions of the terminal 1, portal server 10, and operator terminal 20 are described. Each of the terminals 1, portal server 10, and operator terminal 20 includes hardware including a CPU, a computer-readable storage medium such as a ROM or a RAM, a communication device, a display device, and an input device. The CPU executes a control program stored in the ROM or the like to implement each function of the terminal 1, portal server 10, and operator terminal 20.

The terminal 1 includes a web browser unit 2. The web browser unit 2 is equivalent to a conventional web browser. The terminal 1 implements the browser function through the web browser unit 2.

The portal server 10 includes a portlet processing unit 10A as a processing unit, a portlet container 14 as a storage unit, a portlet arrangement information memory unit 18 as an information management unit, and a portlet parameter information memory unit 19 as a parameter information memory unit.

The portlet processing unit 10A performs a predetermined process concerning portlets when receiving a request from the terminal 1 to display a portal page and performs a process to create the portal page specified by the request and sends the same to the terminal 1.

The portlet processing unit 10A includes a portal screen creation unit 11, a page/portlet management unit 12, a portlet content acquisition unit 13, a portlet content update unit 16, and a portlet deployment unit 17. The portlet processing unit 10A implements the above-mentioned processes by using the portal screen creation unit 11, page/portlet management unit 12, portlet content acquisition unit 13, portlet content update unit 16, and portlet deployment unit 17. The functions of the portal screen creation unit 11, the page/portlet management unit 12, the portlet content acquisition unit 13, the portlet content update unit 16, and the portlet deployment unit 17 are described in detail later.

The portlet container 14 stores contents of portlets 15.

The portlet arrangement information memory unit 18 manages portlet names as portlet identification information of one or more portlets displayed on a portal page and arrangement information on the positions where the portlets are displayed.

The portlet parameter information memory unit 19 stores parameter information used by portlets as input parameters for each portlet.

The operator terminal 20 includes a portlet deployment information transmission unit 22. The portlet deployment information transmission unit 22 stores the parameter information in the portlet parameter information memory unit 19 and also stores the contents of the portlets 15 in the portlet container 14.

The functions of the terminal 1, portal server 10, and operator terminal 20 are described in more detail with reference to FIG. 1.

First, the browser function of the terminal 1 is described.

The web browser unit 2 sends a request to display a portal page to the portal screen creation unit 11 of the portal server 10 based on an instruction from a user. The web browser unit 2 displays information on the portal page received from the portal screen creation unit 11 in a window. This allows the user to browse the portal page in which portlets are displayed at predetermined positions or input predetermined information in the portlet displayed in the portal page.

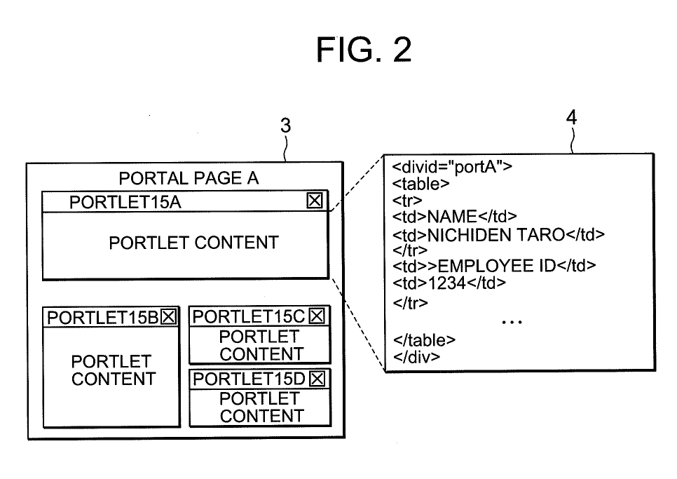

FIG. 2 shows an example of the display screen of the portal page displayed by the web browser unit 2. As shown in FIG. 2, in a portal page A displayed in the display screen 3, portlets 15A to 15D are displayed at predetermined positions, and in each of the portlets A to D, predetermined contents are displayed.

FIG. 2 also shows an example of an HTML document 4 shown to display the contents of the portlet 15A.

Next, the functions of the portlet processing unit 10A of the portal server 10, the portlet arrangement information memory unit 18, the portlet parameter information memory unit 19, and the portlet container 14 are described in detail.

Upon receipt of the request to display a predetermined portal page, the portal screen creation unit 11 transfers the request to the page/portlet management unit 12. The portal screen creation unit 11 also receives, from the page/portlet management unit 12, a list of portlet names of one or more portlets to be displayed in the portal page (hereinafter, referred to as a first list) and the arrangement information of each portlet 15 in the portal page.

Furthermore, the portal screen creation unit 11 sends a request to acquire contents of the portlets to the portlet content acquisition unit 13 using the portlet names listed in the first list as parameters. Upon receipt of the contents of each portlet from the portlet content acquisition unit 13, the portal screen creation unit 11 arranges the received contents in a portal page based on the arrangement information acquired from the page/portlet management unit 12 and returns the same as a response to the terminal 1.

Based on a portal page name included in the request from the terminal 1, the page/portlet management unit 12 acquires the first list which indicates the names of the portlets arranged on the portal page and the arrangement information of the portlets listed in the first list. The page/portlet management unit 12 returns the acquired first list and arrangement information to the portal screen creation unit 11 as a response.

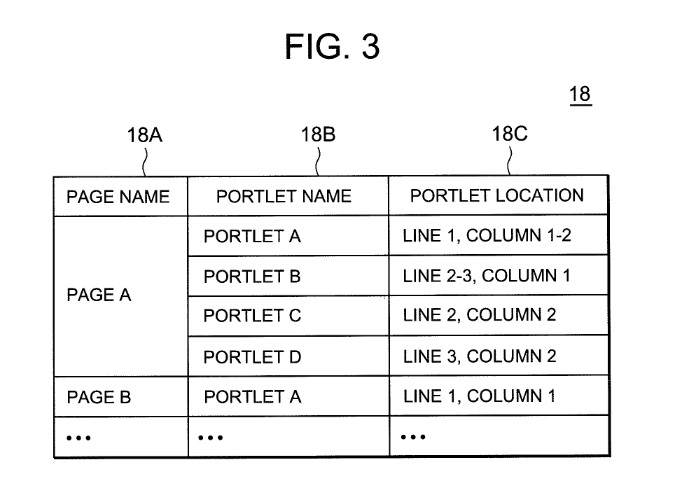

Herein, FIG. 3 is a diagram showing an example of the portlet arrangement information stored in the portlet arrangement information memory unit 18.

As shown in FIG. 3, the portlet arrangement information memory unit 18 includes a page name field 18A, a portlet name field 18B, and a portlet location field 18C. The page name field 18A is a field storing information indicating page names of portal pages. The portlet name field 18B is a field storing information indicating portlet names. The portlet location field 18C is a field storing information indicating the positions where the portlets are to be located.

For example, in the arrangement of the portlets of the portal page A, as shown in FIG. 3, the portlet name filed 18B stores “PORTLETS 15A to 15D” corresponding to “PAGE AT stored in the page name field A. Moreover, the portlet location field 18C stores “LINE 1, COLUMN 2”, “LINES 2-3, COLUMN 1”, “LINE 2, COLUMN 2”, and “LINE 3, COLUMN 2” corresponding to “PORTLETS 15A to 15D” stored in the portlet name field 18B, respectively. The portal page A in which the portlets 15A to 15D are arranged is displayed by the web browser unit 2 of the terminal 1 as shown in the display screen 3 described with reference to FIG. 2.

Upon receipt of the contents of each portlet 15 from the portlet container 14, the portlet content acquisition unit 13 analyzes descriptions of the portlet contents and judges whether the contents include data intended to be passed to another portlet. Data intended to be passed to another portlet is marked up using tags in the portlet contents.

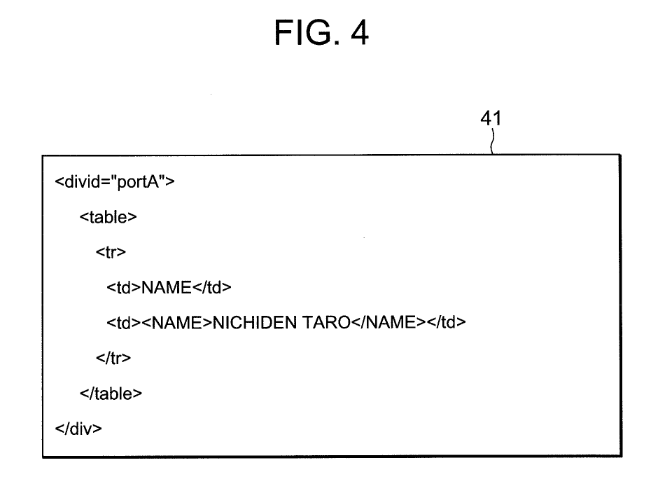

FIG. 4 is a diagram showing an example of portlet contents with data marked up using tags.

As shown in FIG. 4, the data “NICHIDEN TARO” is marked up by tags <NAME> and </NAME>. The tag name and the data between the tags are referred to as a standard parameter name and a standard parameter value, respectively. A tuple of a standard parameter name and a standard parameter value is referred to as a standard parameter (parameter information).

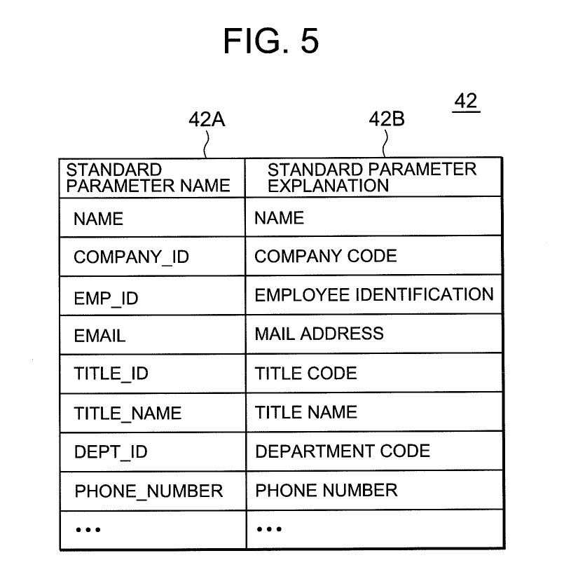

The data shown as the standard parameter value is any value. The standard parameter name is not limited to “NAME” shown in FIG. 4 and can be set to another name in this embodiment, as shown in FIG. 5.

FIG. 5 is a diagram to explain examples of the standard parameter name set in this exemplary embodiment. Table 42 shown in FIG. 5 includes a field 42A showing standard parameter names and a field 42B showing an explanation of the standard parameter names. As shown in field 42A, “NAME”, “COMPANY_ID”, “EMP_ID”, “EMAIL”, “TITLE_ID”, “TITLE_NAME”, “DEPT_ID”, “PHONE_NUMBER” . . . are set as the standard parameter names.

As shown in field 42B, the standard parameter explanations for the standard parameter names are as follows, for: “NAME”, a name is set; “COMPANY_ID”, a company code is set; “EMP_ID”, an employee ID is set; “EMAIL”, an e-mail address is set; “TITLE_ID”, a title code (a position code) is set; “DEPT_ID”, a department ID is set; and “PHONE_NUMBER”, a phone number is set.

The explanation of examples of the standard parameter names set in this exemplary embodiment is made with reference to FIG. 5. However, the standard parameter names described here are not limited to these names.

An analysis of the description of the portlet's contents is performed to determine if the portlet includes standard parameters. If the portlet contents include standard parameters, the portlet content acquisition unit 13 acquires a list of those portlet names which include standard parameters and are to be displayed in the portal page, from the portlet parameter information memory unit 19 (the list is referred to as a second list).

Lastly, the portlet content acquisition unit 13 sends the same number of requests to update the portlets as the number of portlets in the second list. The requests individually include the respective portlet names in the second list and data to be passed as parameters to another portlet.

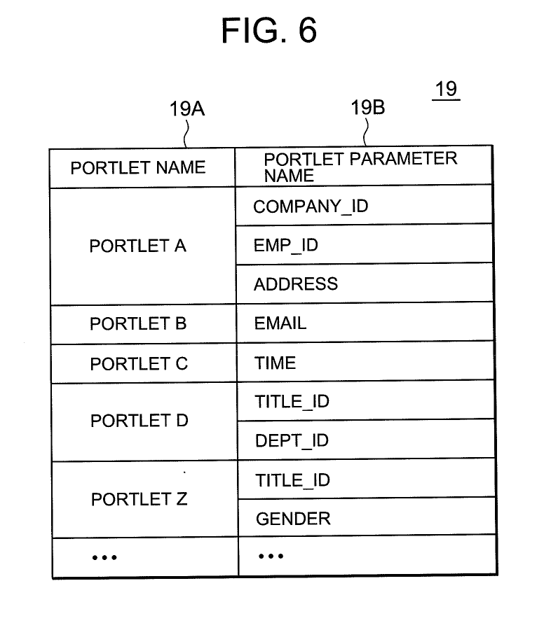

Next, examples of the portlet parameter information stored in the portlet parameter information memory unit 19 are described with reference to FIG. 6.

As shown in FIG. 6, the portlet parameter information memory unit 19 includes a portlet name field 19A and a portlet parameter name field 19B. The portlet name field 19A stores information indicating portlet names. The portlet parameter name field 19B stores information indicating portlet parameter names set corresponding to each portlet name. The portlet parameter name field 19B stores one or more standard parameter names set for each portlet.

For example, in the portlet name field 19A, “PORTLET 15A”, “PORTLET 15B”, “PORTLET 15C”, “PORTLET 15D”, “PORTLET 15Z” . . . are set. In the portlet parameter name field 19B, “COMPANY_ID, EMP_ID, jyuusho”, “EMAIL”, “jikan”, “TITLE_ID, DEPT_ID”, and “TITLE_ID, seibetsu” are set corresponding to the portlets 15A to 15D and 15Z, respectively.

The portlet container 14 manages the portlets 15 (the portlets 15A to 15D and 15Z in the example shown in FIG. 1). Upon receipt of a request including a portlet name as a parameter from the portlet content acquisition unit 13, the portlet container 14 requests the portlet 15 to provide the contents corresponding to the received portlet name and transfers the response from the portlet 15 to the portlet content acquisition unit 13.

Upon receipt of a request including a portlet name as a parameter from the portlet content update unit 16, the portlet container 14 requests the portlet 15 to update the contents thereof corresponding to the received portlet name and transfers the response from the updated portlet 15 to the portlet content acquisition unit 13.

Upon receipt of a request to update the portlet 15 from the portlet content acquisition unit 13, the portlet content update unit 16 sends to the portlet container 14 a request to update the contents of the portlet. The request includes as input parameters the portlet name included in the received request and data to be passed to another portlet (standard parameter).

Upon receipt of a request to deploy the portlet 15 from the portlet deployment information transmission unit 22 of the operator terminal 20, the portlet deployment unit 17 stores the received portlet 15 to be deployed in the portlet container 14 and stores the portlet parameter information of the portlet 15 in the portlet parameter information memory unit 19.

Next, the functions of the operator terminal 20 are described in detail.

The portlet deployment information transmission unit 22 sends the portlet 15 and portlet parameter definition information 21 to the portlet deployment unit 17 of the portal server 10 based on an operational input by the operator.

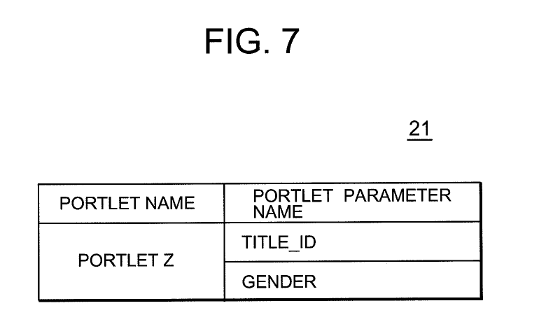

Herein, FIG. 7 is a diagram showing an example of the portlet parameter definition information 21. FIG. 7 shows the portlet parameter definition information defined for the above described portlet 15Z.

As shown in FIG. 7, the portlet parameter definition information 21 of the portlet 15Z includes “PORTLET 15Z” as the portlet name and “TITLE_ID, seibetsu” as the portlet parameter name.

When the thus-defined portlet parameter definition information 21 of the portlet 15 is sent to the portlet deployment unit 17 by the portlet deployment information transmission unit 22, the portlet deployment unit 17 stores the portlet 15Z in the portlet container 14 and stores the information on the portlet 15Z in the portlet parameter information memory unit 19.

Accordingly, the portlet 15Z is stored in the portlet container 14 as shown in FIG. 1, and “PORTLET 15Z” as the portlet name and “TITLE_ID, seibetsu” as the portlet parameter name are stored in the portlet parameter information memory unit 19 as shown in FIG. 6.

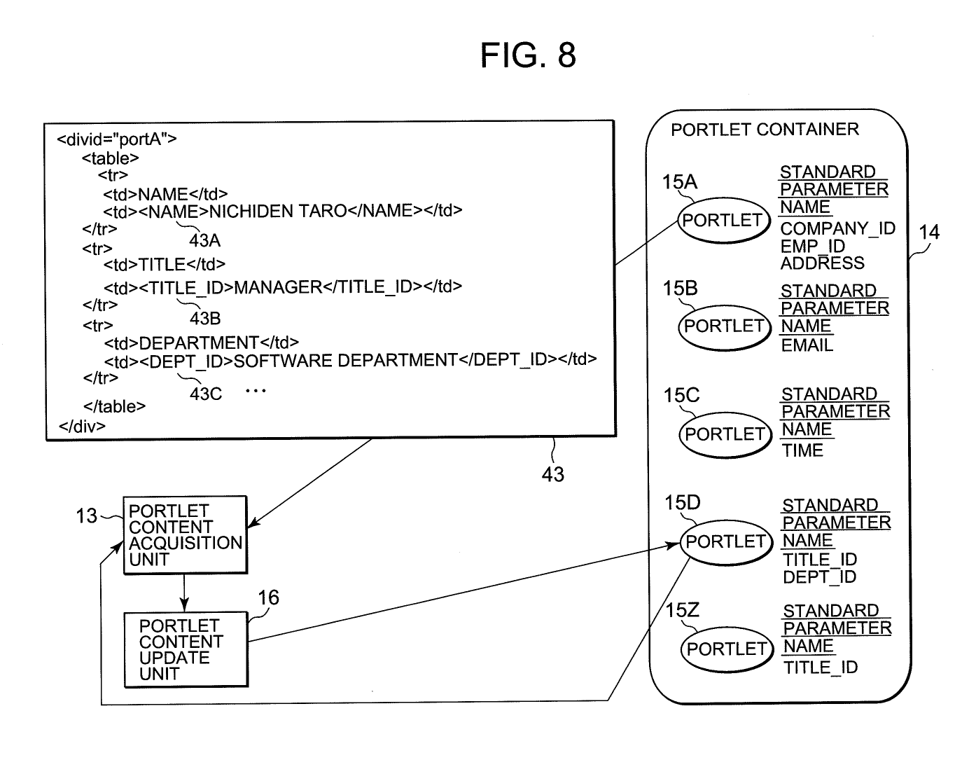

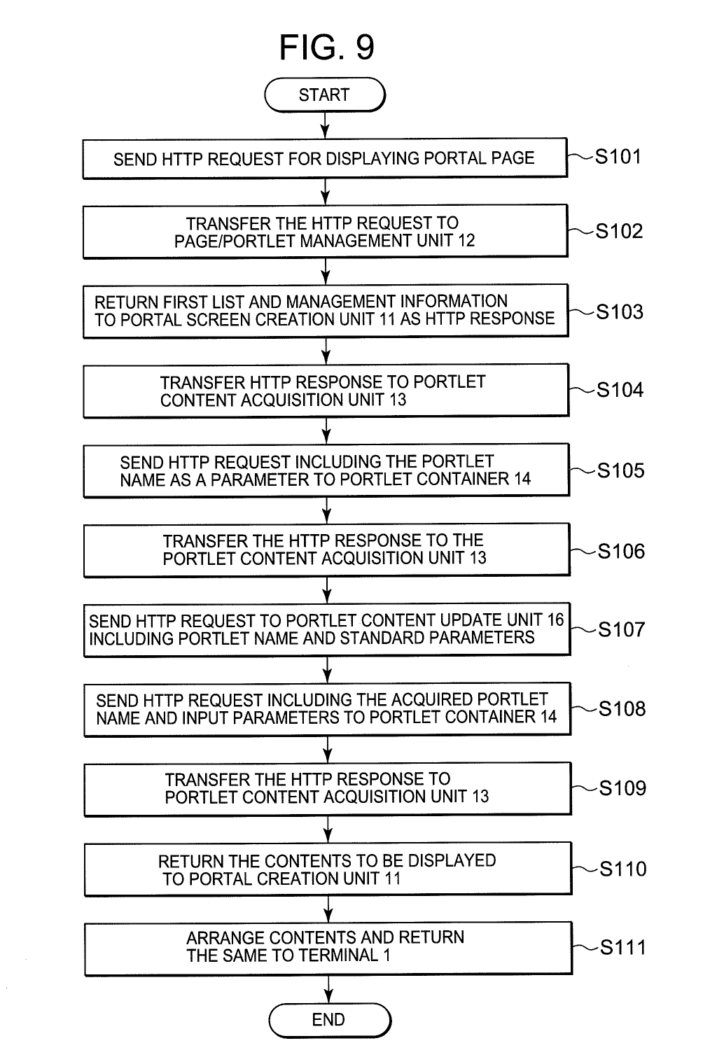

Next, referring to FIGS. 1 and 9, a detailed description is given of an operation of the portal server 10 when the above-described request to display the portal page A is sent from the terminal 1 to the portal server 10. Herein, FIG. 8 is a diagram to explain a process by the portlet content acquisition unit 13, portlet container 14, and portlet content update unit 16 for update of portlets. Also, FIG. 9 is a flowchart to explain an operation of the portal server A in response to receipt of the request to display the web page A form the terminal 1.

First, based on an operation by the user, the web browser unit 2 of the terminal 1 sends an HTTP request to the portal screen creation unit 11 of the portal server 10 to display a portal page (S101).

In the HTTP request, for example, the portal page A is set as a parameter to display a portal page.

Upon receipt of the HTTP request from the web browser unit 2, the portal screen creation unit 11 transfers the HTTP request to the page/portlet management unit 12 (S102).

The page/portlet management unit 12 acquires the first list and the arrangement information from the page/portlet management information by the parameter (portal page name) included in the HTTP request transferred from the portal screen creation unit 11. The first list indicates the portlet names of the portlets arranged on the portal page specified by the portal page name. The arrangement information concerns the arrangement of the portlets listed in the first list. The page/portlets management information is stored in the portlet arrangement information memory unit 18. The page/portlet management unit 12 then returns the first list and the arrangement information to the portal screen creation unit 11 as an HTTP response (S103). [These reference numbers seem to be references to steps in a method, but they do not appear in the drawings. If there a flowchart figure in the Japanese specification that should be added to the U.S. application?]

For example, the page/portlet management unit 12 acquires the first list indicating the portlets 15A to 15D by the portal page A as a key based on the page/portlet management information stored in the page/portlet management unit 12 described with reference to FIG. 3. The page/portlet management unit 12 returns the first list and the arrangement information of the portlets 15A to 15D to the portal screen creation unit 11 as the HTTP response.

Upon receipt of the HTTP response from the page/portlet management unit 12, the portal screen creation unit 11 transfers the HTTP response to the portlet content acquisition unit 13 as an HTTP request (S104).

For each of the portlets listed in the first list, the portlet content acquisition unit 13 sends an HTTP request including the portlet name as a parameter to the portlet container 14 based on the first list included in the HTTP request transferred from the portal screen creation unit 11 (S105).

For example, for the portlets 15A to 15D listed in the first list, the portlet content acquisition unit 13 sends HTTP requests including the portlets 15A to 15D as the parameters, respectively.

Upon receipt of each of the HTTP requests from the portlet content acquisition unit 13, the portlet container 14 sends an HTTP request to acquire contents to the portlet 15 having the same portlet name as that included in the received HTTP request.

For example, when the HTTP request includes portlet 15A as the parameter, the portlet container 14 sends an HTTP request to acquire contents of portlet 15A to portlet 15A. This process is also performed in the same manner when the received HTTP request includes any one of portlets 15B to 15D as a parameter as in the case where the received HTTP includes portlet 15A.

Upon receipt of the HTTP request to acquire contents from the portlet container 14, the portlet 15 returns HTML-format contents to the portlet container 14 as a response.

For example, when the portlet 15A receives the HTTP request to acquire contents from the portlet container 14, the portlet 15A returns HTML-format contents 43 to the portlet container 14 as an HTTP response. Moreover, when receiving the HTTP requests to acquire contents from the portlet container 14, each of the portlets 15B to 15D returns HTML-format contents to the portlet container as an HTTP response in the same way as in the case of portlet 15A.

Upon receiving the HTTP response from the portlet 15, the portlet container 14 transfers the HTTP response to the portlet content acquisition unit 13 (S106).

For example, when the HTTP response is returned from portlet 15A, the portlet container 14 transfers the HTTP response to the portlet content acquisition unit 13. This process is also performed in the same way when the HTTP response is returned from any one of portlets 15B to 15D as in the case of portlet 15A.

The HMTL-format contents 43 shown in upper left of FIG. 8 shows an example of the HTML-format contents returned from portlet 15A to the portlet content acquisition unit 13 as described above.

The contents 43 include three standard parameters 43A to 43C. The standard parameter 43A is <NAME>NICHIDEN TARD<NAME>. The standard parameter 43B is <TITLE>MANAGER<TITLE>. The standard parameter 43C is <DEPT>SOFTWARE DEPARTMENT<DEPT>. The HTML-format contents 43 including these standard parameters 43A to 43C are returned from the portlet 15A through the portlet container 14 to the portlet content acquisition unit 13 as an HTTP response.

The portlet content acquisition unit 13 analyses the contents of the portlet 15 included in the HTTP response returned from the portlet container 14. When judging that the contents include a standard parameter, the portlet content acquisition unit 13 acquires the tuple of the tag having the same name as the standard parameter name and the standard parameter value as the value of the tag, which are included in the standard parameter, as the standard parameter.

For example, in the case of the contents of the portlet 15A shown in the upper left of FIG. 8, the portlet content acquisition unit 13 acquires “NAME” and “NICHIDEN TARO”, “TITLE_ID” and “MANAGER”, and “DEPT_ID” and “SOFTWARE DEPARTMENT” as the standard parameters. The portlet content acquisition unit 13 acquires the second list indicating the names of the portlets that include the standard parameter names included in the acquired standard parameters and which are to be displayed on the portal page. The second list is acquired from the portlet parameter management information stored in the portlet parameter information memory unit 19.

When the three standard parameters 43A to 43C are acquired as described above, the portlet content acquisition unit 13 acquires the names of the portlets having any one of the standard parameter names “NAME”, “TITLE_ID”, and “DEPT_ID”. The acquired portlet names are limited to the portlets to be displayed on the portal page requested.

For example, for the portlet 15A, as the portlet names to be listed in the second list, the portlet content acquisition unit 13 acquires portlet 15D with “TITLE_ID” and “DEPT_ID” set as the portlet parameter names as shown in FIG. 6. “TITLE_ID” is also set as a portlet parameter name of the portlet 15Z, but the portlet 15Z is not listed in the second list because portlet 15Z is not a portlet to be displayed on the portal page A.

Next, the portlet content acquisition unit 13 sends to the portlet content update unit 16 an HTTP request including the portlet name listed in the acquired second list and the input parameters thereof (standard parameters) as parameters (S107).

For example, based on the response from the portlet 15A, the portlet content acquisition unit 13 sends to the portlet content update unit 16 an HTTP request including the portlet 15D and the input parameters thereof “TITLE_ID=MANAGER” and “DEPT_ID=SOFTWARE DEPARTMENT” as parameters.

When the portlet content update unit 16 acquires the portlet name and input parameters from the HTTP request received from the portlet content acquisition unit 13 and then sends an HTTP request to update contents to the portlet container 14, the HTTP request includes the acquired portlet name and input parameters as parameters (S108).

For example, when the portlet content update unit 16 receives an HTTP request including “PORTLET 15D” as the portlet name and “TITL_ID−manager” and “DEPT_ID=SOFTWARE DEPARTMENT” as the input parameters, the portlet content update unit 16 sends an HTTP request to update the contents which includes “TITLE_ID=MANAGER” and “DEPT_ID=SOFTWARE DEPARTMENT” as parameters to the portlet container 14.

Upon receipt of the HTTP request from the portlet content update unit 16 to update contents, the portlet container 14 sends an HTTP request including an input parameter as a parameter to the portlet 15 having the same portlet name as the portlet name included in the HTTP request.

For example, when the HTTP request includes “PORTLET 15D”, “TITLE_ID=MANAGER”, and “DEPT_ID=SOFTWARE DEPARTMENT” as parameters, the portlet container 14 sends to the portlet 15D an HTTP request to update contents which includes the input parameters “TITLE_ID=MANAGER”, and “DEPT_ID=SOFTWARE DEPARTMENT” as parameters.

Upon receipt of the HTTP request from the portlet container 14 to update contents, the portlet 15 performs a process to update contents using the input parameters included in the request and then returns the updated contents to the portlet container 14 as an HTTP response.

For example, upon receipt of an HTTP request from the portlet container 14 to update the contents which includes the input parameters “TITLE_ID=MANAGER” and “DEPT_ID=SOFTWARE DEPARTMENT”, the portlet 15D performs a process to update its contents using “TITLE_ID=MANAGER” and “DEPT_ID=SOFTWARE DEPARTMENT” included in the request and then returns the updated contents to the portlet container 14 as an HTTP response.

The portlet container 14 transfers the HTTP response returned from the portlet 15 to the portlet content acquisition unit 13 (S109).

For example, the portlet container 14 transfers the HTTP response returned from the portlet 15D to the portlet content acquisition unit 13.

When acquiring the contents of the portlet 15 from the portlet container 14, the portlet content acquisition unit 13 returns the contents of the portlet to be displayed in a portal page to be displayed in the terminal 1 to the portal creation unit 11 (S110).

For example, when acquiring the contents of the portlet 15A to 15D from the portlet container 14 (the updated contents when the contents are updated by the above-described updating process), the portlet content acquisition unit 13 returns the contents of the portlet 15A to 15D to the portal creation unit 11.

The portal screen creation unit 11 arranges the contents of the portlet 15 returned from the portlet content acquisition unit 13 on a portal page based on the arrangement information of the portlet 15 in the portal page and then returns the same as an HTTP response to the web browser unit 2 of the terminal 1 (S111).

For example, the portal screen creation unit 11 arranges the contents of the portlets 15A to 15D returned from the portlet content acquisition unit 13 (the updated contents in the case of the portlet of which the contents are updated by the above described update process) on the portal page A based on the arrangement information of the portlets 15A to 15D in the portal page A. Then the portal screen creation unit 11 returns the same (the contents of the portlets 15A to 15D) as an HTTP response to the web browser unit 2 of the terminal 1.

The browser unit 2 of the terminal 1 displays the portal page including the portlet 15 based on the HTTP response sent from the portal screen creation unit 11.

For example, based on the information used to display the portal page A sent from the portal screen creation unit 11, the web browser unit 2 of the terminal 1 displays the portal page A where the portlets 15A to 15D are arranged at predetermined positions.

Since the web browser 2 is configured to display the portal page in such a manner, the user can see a portal page in which data linking of the portlets displayed on the portal page is implemented.

According to the portlet cooperation system 100 of this exemplary embodiment, it is possible to easily implement data linking among portlets on a portal page without needing special care from developers of the portlets.

Specifically, when the portal server 10 receives a request to display a portal page from the terminal 1 and judges that the data (standard parameter value) to be passed to another portlet 15 is marked up by tags (standard parameter name) in the contents of the portlets 15 to be displayed on the portal page, the portal server 10 can determine a proper cooperating portlet according to the marked-up standard parameter and send the data to the cooperating portlet. As a result, it is possible to implement data linking between the portlets on the portal page transparently.

Also, the above-described embodiment is a preferred embodiment of the present invention, however, the scope of the invention is not limited to only the above embodiment, but the invention can be implemented with various modifications without departing from the scope of the invention. For example, the present invention can be applied to a component cooperation device, a component cooperation method, and a component cooperation system for data linking in which the portal page and portlets in the above embodiment are replaced with a web page and components, respectively.

What is claimed is:

1. A component cooperation device configured to communicate with a terminal through a network and provide a web page to the terminal in response to a request to display the web page, the device comprising:
an information management unit configured to manage component identification information and component arrangement information of one or more components to be displayed on the web page;
a storage unit configured to store contents of the one or more components;
a parameter information memory unit configured to store input parameter information for each of the components;
a processing unit configured to create the web page specified by the request and send the web page to the terminal, in response to receipt of the request to display the web page,
wherein the processing unit receives a first list and the component arrangement information from the information management unit upon receipt of the request from the terminal, the first list including the component identification information of the one or more components to be displayed on the web page,
wherein the processing unit receives the contents of the one or more components stored in the storage unit based on the component identification information of the first list,
wherein the processing unit receives a second list from the parameter information memory unit if the received contents includes a standard parameter information, the second list indicating the component identification information of the one or more components that includes the standard parameter information,
wherein the processing unit updates the contents of the components indicated by the component identification information in the second list according to the standard parameter information included in the received contents, and
wherein the processing unit creates the web page with the received contents and the updated contents according to the component arrangement information.

2. The component cooperation device according to claim 1,
wherein the standard parameter information is a parameter value marked by a standard parameter name, a standard parameter includes the standard parameter name and the standard parameter information,
wherein the processing unit receives the second list from the parameter information memory unit if the received contents includes the standard parameter, the second list including the component identification information of the components including the standard parameter, and
wherein the processing unit updates the components indicated by the component identification information included in the second list by using the standard parameter value.

3. The component cooperation device according to claim 2,
wherein the components are stored in the storage unit as HTML (hyper text markup language) format data, and
wherein the standard parameter is a tag having the HTML format.

4. The component cooperation device according to claim 1,
wherein the second list indicates the component identification information of the components to be displayed on the web page specified by the request.

5. The component cooperation device according to claim 1, wherein the components are portlets.

6. A component cooperation method for a component cooperation device configured to communicate with a terminal through a network and provide a web page to the terminal in response to a request from the terminal to display the web page, the method comprising:
performing a predetermined process concerning components for the web page in response to receipt of the request to display the web page;
creating the web page specified by the request; and
sending the web page to the terminal,
wherein the predetermined process comprises:
receiving a first list and component arrangement information upon the receipt of the request, the first list including component identification information of the components to be displayed on the web page,
receiving contents of the components corresponding to the component identification information included in the first list, stored in a storage unit,
receiving a second list from a parameter information memory unit if a description of the received contents includes standard parameter information, the second list indicating component identification information of the components including the standard parameter information,
updating contents of the components indicated in the second list according to the standard parameter information, and
wherein the web page is created with the received contents and the updated contents according to the component arrangement information.

7. The component cooperation method according to claim 6,
wherein the standard parameter information is a parameter value marked by a standard parameter name, a standard parameter includes the standard parameter name and the standard parameter information, and
wherein the processing unit receives the second list from the parameter information memory unit if a description of the received contents includes the standard parameter, the second list including the component identification information of the components including the standard parameter, and
wherein the processing unit updates the components indicated by the component identification information included in the second list by using the parameter value.

8. The component cooperation method according to claim 7,
wherein the components are stored in the storage unit as HTML (hyper text markup language) format data, and
wherein the standard parameter is a tag having the HTML-format.

9. The component cooperation method according to claim 7,
wherein the second list indicates the component identification information of the components to be displayed on the web page specified by the request.

10. A method of updating components of a web page, comprising:
identifying a standard parameter in content of a first component for the web page, the standard parameter having a name and a value;
identifying a second component of the web page having content that includes the standard parameter name that is also in the content of the first component;
updating the content of the second component by changing the standard parameter in the content of the second component to have the standard parameter value of the standard parameter in the content of the first component; and
creating the web page from the content of the first component and the updated content of the second component.

11. The method according to claim 10, wherein a first list comprises names of components associated with the web page, and a second list comprises an association of component names with standard parameter names within content of the component names, wherein said identifying the second component of the web page comprises identifying the second component if the second component is in the first list associated with the web page, and the second list has the standard parameter associated with both the first component and the second component.

12. The method according to claim 11, the method further comprising storing the updated content of the second component in a portlet container.

13. The method according to claim 12, wherein the first and second components are portlets,

14. A computer readable medium recording thereon a program for enabling computer to execute a method of a component cooperation method for a component cooperation device configured to communicate with a terminal through a network and provide a web page to the terminal in response to a request from the terminal to display the web page, the method comprising:
performing a predetermined process concerning components for the web page in response to receipt of the request to display the web page;
creating the web page specified by the request; and
sending the web page to the terminal,
wherein the predetermined process comprises:
receiving a first list and component arrangement information upon the receipt of the request, the first list including component identification information of the components to be displayed on the web page,
receiving contents of the components corresponding to the component identification information included in the first list, stored in a storage unit,
receiving a second list from a parameter information memory unit if a description of the received contents includes standard parameter information, the second list indicating component identification information of the components including the standard parameter information,
updating contents of the components indicated in the second list according to the standard parameter information, and
wherein the web page is created with the received contents and the updated contents according to the component arrangement information.

15. The computer readable medium according to claim 14,
wherein the standard parameter information is a parameter value marked by a standard parameter name, the standard parameter name and standard parameter information comprising a standard parameter, and
wherein the processing unit receives the second list from the parameter information memory unit if a description of the received contents includes the standard parameter, the second list including the component identification information of the components including the standard parameter, and
wherein the processing unit updates the components indicated by the component identification information included in the second list by using the parameter value.

16. The computer readable medium according to claim 15,
wherein the components are stored in the storage unit as HTML (hyper text markup language) format data, and
wherein the standard parameter is a tag having the HTML-format.

17. The component readable medium according to claim 15,
wherein the second list indicates the component identification information of the components to be displayed on the web page specified by the request.

18. A computer readable medium recording thereon a program for enabling computer to execute a method of updating components of a web page, comprising:
identifying a standard parameter in content of a first component for the web page, the standard parameter having a name and a value;
identifying a second component of the web page having content that includes the standard parameter name that is also in the content of the first component;
updating the content of the second component by changing the standard parameter in the content of the second component to have the standard parameter value of the standard parameter in the content of the first component; and
creating the web page from the content of the first component and the updated content of the second component.

19. The component readable medium according to claim 18, wherein a first list comprises names of components associated with the web page, and a second list comprises an association of component names with standard parameter names within content of the component names, wherein said identifying the second component of the web page comprises identifying the second component if the second component is in the first list associated with the web page, and the second list has the standard parameter associated with both the first component and the second component.

20. The component readable medium according to claim 19, the method further comprising storing the updated content of the second component in a portlet container.

21. The component readable medium according to claim 20, wherein the first and second components are portlets,
